(19) United States
(12) Patent Application Publication
(10) Pub. No.: US 2022/0043818 A1
(43) Pub. Date: Feb. 10, 2022

(54) Separate Runtime Data From Metadata

(71) Applicant: SAP SE, Walldorf (DE)

(72) Inventor: Torsten Quast, Heidelberg (DE)

(21) Appl. No.: 16/988,493

(22) Filed: Aug. 7, 2020

(51) Int. Cl. G06F 16/2453; G06F 16/2457; G06F 16/248; G06F 16/215

(52) U.S. Cl. CPC G06F 16/24539; G06F 16/215; G06F 16/248; G06F 16/24573

(57) ABSTRACT

Runtime data for generating visualizations based on a query is stored separate from metadata in memory, thereby allowing for other runtime data for different visualizations based on the same query to reference that metadata without duplicating the metadata in memory. First metadata of first query data received from a server is loaded into a metadata store in memory. First runtime data for a first visualization is loaded in memory separately. The first runtime data uses the first metadata without reloading the first metadata on the one or more primary memory devices. Second runtime data for a second visualization may also use the first metadata of the metadata store such that the first metadata is not reloaded into the memory.

### BACKGROUND

The present disclosure pertains to memory management and in particular to separate runtime data from metadata in memory.

Software applications can be used to visualize and analyze large sets of data. In certain situations, a user may need to review numerous visualizations of data at the same time in order to gain an understanding for decision making. Generating and presenting numerous visualizations may require numerous queries be made to a backend server at the same time, which may strain the computing resources of the server in addition to those of the client. Furthermore, loading data for numerous visualizations into memory may cause performance regressions and memory shortages, even for more capable client computers such as desktop and laptop computers. Depending on the extent of memory required, less capable client computers such as tablets and smartphones may be not be capable of presenting all of the visualizations.

The present disclosure addresses these issue and others, as further described below.

### SUMMARY

One embodiment provides a computer system. The computer system includes one or more processors. The computer system also includes one or more primary memory devices coupled to the one or more processors. The computer system also includes one or more machine-readable medium coupled to the one or more processors. The one or more machine-readable medium storing computer program code comprising sets instructions executable by the one or more processors. The instructions being executable to obtain a first request from an application for a first visualization based on a first query of a server. The instructions further being executable to load first metadata of first query data received from the server into a metadata store on the one or more primary memory devices. The instructions further being executable to load first runtime data for the first visualization into the one or more primary memory devices separate from the metadata store. The first runtime data use the first metadata of the metadata store without reloading the first metadata on the one or more primary memory devices. The instructions further being executable to generate the first visualization based on the first runtime data and the first metadata. The instructions further being executable to obtain a second request from the application for a second visualization based on the first query that the first visualization is based on. In response to the second request, the instructions further being executable to determine that the first metadata of the first query data is loaded in the metadata store. In response to the determination that the first metadata of the first query is loaded in the metadata store, the instructions further being executable to load second runtime data for the second visualization into the one or more primary memory devices separate from the metadata store. The second runtime data uses the first metadata of the metadata store such that the first metadata is not reloaded into the one or more primary memory devices in response to the second request. The instructions further being executable to generate the second visualization based on the second runtime data and the first metadata.

Another embodiment provides one or more non-transitory computer-readable medium storing computer program code. The computer program code includes sets of instructions to obtain a first request from an application for a first visualization based on a first query of a server. The computer program code further includes sets of instructions to load first metadata of first query data received from the server into a metadata store on one or more primary memory devices. The computer program code further includes sets of instructions to load first runtime data for the first visualization into the one or more primary memory devices separate from the metadata store. The first runtime data uses the first metadata of the metadata store without reloading the first metadata on the one or more primary memory devices. The computer program code further includes sets of instructions to generate the first visualization based on the first runtime data and the first metadata. The computer program code further includes sets of instructions to obtain a second request from the application for a second visualization based on the first query that the first visualization is based on. In response to the second request, the computer program code further includes sets of instructions to determine that the first metadata of the first query data is loaded in the metadata store. In response to the determination that the first metadata of the first query data is loaded in the metadata store, the computer program code further includes sets of instructions to load second runtime data for the second visualization into the one or more primary memory devices separate from the metadata store. The second runtime data uses the first metadata of the metadata store such that the first metadata is not reloaded into the one or more primary memory devices in response to the second request. The computer program code further includes sets of instructions to generate the second visualization based on the second runtime data and the first metadata.

Another embodiment provides a computer-implemented method. The method includes obtaining, by a computer system, a first request from an application for a first visualization based on a first query of a server. The method further includes loading, by the computer system, first metadata of first query data received from the server into a metadata store on one or more primary memory devices of the computer system. The method further includes loading, by the computer system, first runtime data for the first visualization into the one or more primary memory devices separate from the metadata store. The first runtime data uses the first metadata of the metadata store without reloading the first metadata on the one or more primary memory devices. The method further includes generating, by the computer system, the first visualization based on the first runtime data and the first metadata. The method further includes obtaining, by the computer system, a second request from the application for a second visualization based on the first query that the first visualization is based on. In response to the second request, the method further includes determining, by the computer system, that the first metadata of the first query data is loaded in the metadata store. In response to the determination that the first metadata of the first query is loaded in the metadata store, the method further includes loading, by the computer system, second runtime data for the second visualization into the one or more primary memory devices separate from the metadata store. The second runtime data uses the first metadata of the metadata store such that the first metadata is not reloaded into the one or more primary memory devices in response to the second request. The method further includes generating, by the computer system, the second visualization based on the second runtime data and the first metadata.

The following detailed description and accompanying drawings provide a better understanding of the nature and advantages of the present disclosure.

### BRIEF DESCRIPTION OF THE DRAWINGS

FIG. 1 shows a diagram of a system including a client and an Online Analytical Processing (OLAP) system, according to an embodiment.

FIG. 2 shows an exemplary user interface for visualizing data, according to an embodiment.

FIG. 3 shows a diagram of a client loading a query into memory for each visualization based on the query.

FIG. 4 shows a diagram of a client loading a query into memory once and reused for each visualization based on the query, according to an embodiment.

FIG. 5 shows a flowchart of an exemplary method for loading query data into memory, according to an embodiment.

FIG. 6 shows a simplified class diagram showing separation of runtime data and metadata, according to an embodiment.

FIG. 7 shows a diagram of a client sharing a filter among visualizations, according to an embodiment.

FIG. 8 shows a diagram of hardware of a special purpose computing machine for implementing separate runtime data from metadata.

### DETAILED DESCRIPTION

In the following description, for purposes of explanation, numerous examples and specific details are set forth in order to provide a thorough understanding of the present disclosure. Such examples and details are not to be construed as unduly limiting the elements of the claims or the claimed subject matter as a whole. It will be evident, based on the language of the different claims, that the claimed subject matter may include some or all of the features in these examples, alone or in combination, and may further include modifications and equivalents of the features and techniques described herein.

In the figures and their corresponding description, while certain elements may be depicted as separate components, in some instances one or more of the components may be combined into a single device or system. Likewise, although certain functionality may be described as being performed by a single element or component within the system, the functionality may in some instances be performed by multiple components or elements working together in a functionally coordinated manner. In addition, hardwired circuitry may be used independently or in combination with software instructions to implement the techniques described in this disclosure. The described functionality may be performed by custom hardware components containing hardwired logic for performing operations, or by any combination of computer hardware and programmed computer components. The embodiments described in this disclosure are not limited to any specific combination of hardware circuitry or software. The embodiments can also be practiced in distributed computing environments where operations are performed by remote data processing devices or systems that are linked through one or more wired or wireless networks. Furthermore, the terms “first,” “second,” “third,” “fourth,” “fifth,” “sixth,” “seventh,” “eighth,” “ninth,” “tenth,” etc., used herein do not necessarily indicate an ordering or sequence unless indicated. These terms may be used for differentiation between different objects or elements within specifying an order.

As mentioned above, software applications can be used to visualize and analyze large sets of data. In certain situations, a user may need to review numerous visualizations of data at the same time in order to gain an understanding for decision making. Generating and presenting numerous visualizations may require numerous queries be made to a backend server at the same time, which may strain the network and computing resources of the server in addition to those of the client. Furthermore, loading data for numerous visualizations into memory may cause performance regressions and memory shortages, even for more capable client computers such as desktop and laptop computers. Depending on the extent of memory required, less capable client computers such as tablets and smartphones may be not be capable of presenting all of the visualizations.

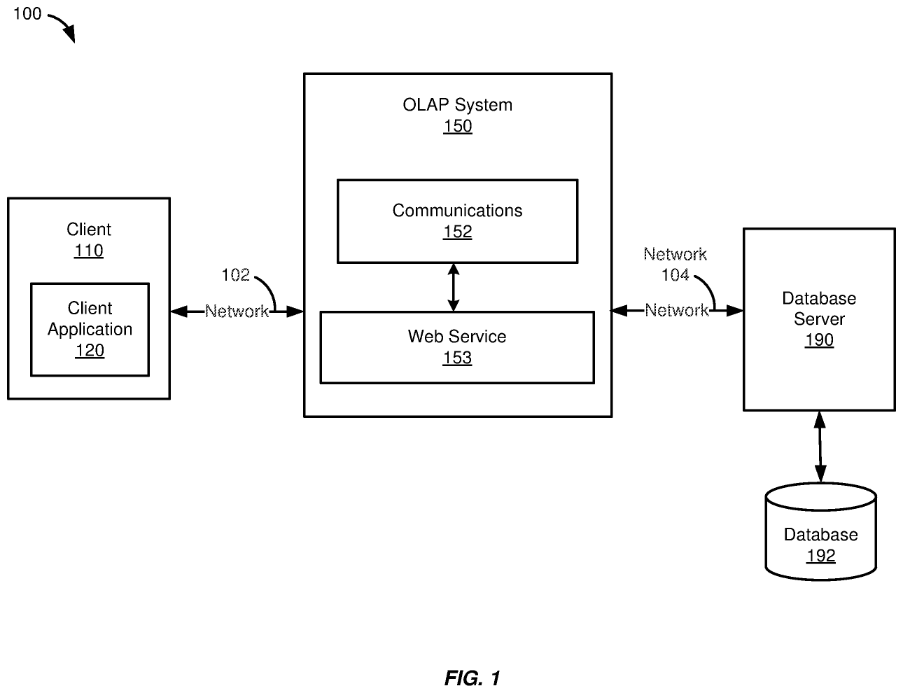

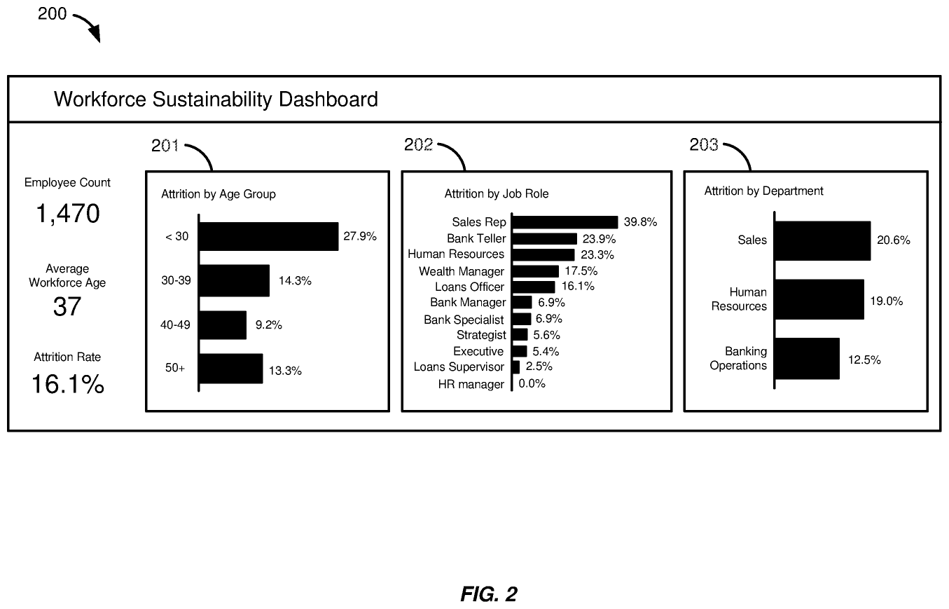

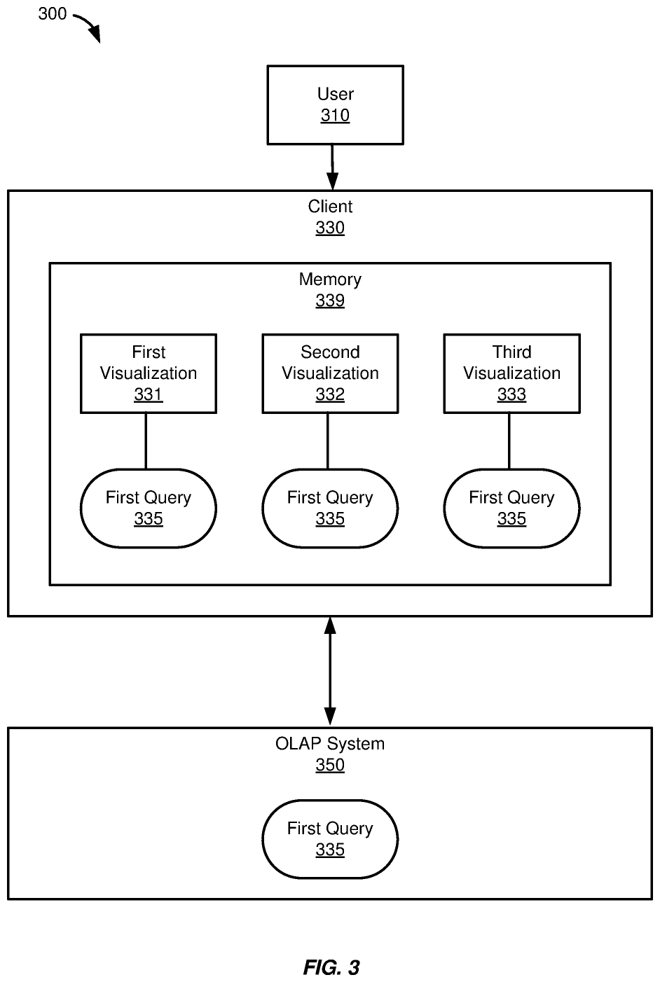

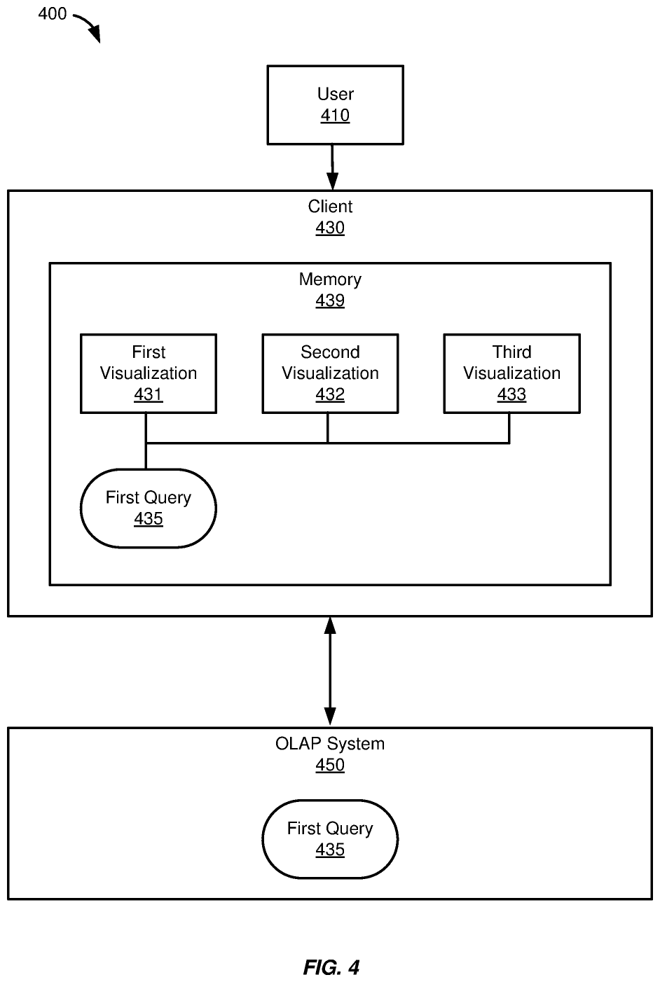

Analytics applications are one example of applications that may require numerous visualizations of data to be presented at one time. Analytics applications running a client may generate visualizations based on queries to an Online Analytical Processing (OLAP) system. The structure of an OLAP system is described with respect FIG. 1, an exemplary user interface at the client is described with respect to FIG. 2, certain memory management techniques are described with respect to FIG. 3, and improved memory management by using separate runtime data and metadata, which may be implemented in the system of FIG. 1, is described below with respect to FIG. 4.

FIG. 1 shows a diagram of a 100 system including a client computer system 110 and an OLAP server system 150, according to an embodiment. The client computer system 110 may be a personal computer, a laptop, a smart phone, or a tablet, for example. The client computer 110 is running a client application 120. The client application 120 may be web-based or may reside locally on the client 110. The client application 120 may be used to interact with and to configure and view reports and visualizations of data, for example.

The client 110 may communicate with the OLAP system 150 over a network 102. The OLAP system 150 may be used to collect, store, and manage data use for analytics. The OLAP system 150 may be configured to provide a user interface for the client application 120. The user interface may be provided via a web service 153 using a cloud-based computer network architecture, for example. The OLAP system 150 may be implemented as an individual computer hardware server or as an array of computer hardware servers logically coupled together and working in a functionally coordinated manner.

The OLAP system 150 may further be in communication with a database server 190 over a network 104. The database server 190 is further in communication with a database 192 adapted to store data. In some embodiments, the database server 190 and the database 192 are part of the OLAP system 150. The database server 190 can be configured to perform data accesses operations on data stored in the databases 192. The database server 192 may be implemented as an individual computer hardware server or as an array of computer hardware servers logically coupled together and working in a functionally coordinated manner. Depending on the type of database server 190, data operations may range from simple operations, such as storing and retrieving data, to more complex operations such as calculating statistics based on the data, or arranging, modifying, or formatting data.

The database server 190 may further include a database management system (“DBMS”) that communicates with the one or more databases for the purposes of storing and retrieving data to or from the databases. A DBMS may be configured as a computer software application that interacts with the database and other applications or users to capture and analyze data. The DBMS may be designed to allow for definition, creation, querying, update, and administration of databases, for example. A database “query” may comprise a request for data or information from a database table or combination of database tables (or other data structures) in the database. Queries are the mechanism for retrieving information from a database and generally consist of questions presented to the database in a predefined format. This data may be generated as results returned by the SQL, or as pictorials, graphs, etc. The results may be returned to a client computer as a query response. The query response includes query data from querying the database and metadata of the database, which the client may use in generating visualizations, for example, as further described below.

The network 102 and network 104 may be implemented as a single wired or wireless network, or multiple separate networks in communication with one another. For example, the networks described herein can be implemented as a local area network (“LAN”), wide-area network (“WAN”), combination of LANs and WANs, the Internet, for example. Further, the network 102 and 104 may be implemented in a cloud-based network configuration.

As described herein, certain applications (e.g., a client application of a cloud-based analytics platform) may open numerous queries at the same time. The same query may be opened multiple time in order to show different visualizations or to analyze different aspects of the data.

FIG. 2 shows an exemplary user interface 200 for visualizing data, according to an embodiment. The user interface 200 may be presented by a client computer, such as the client computer 110 of FIG. 1, for example. The user interface 200 may be provided by a web service using a cloud-based computer network architecture, such as the web service 153 of the OLAP system 150 of FIG. 1, for example. The data visualized in the user interface 200 may be obtained by querying an OLAP system, such as the OLAP system 150 of FIG. 1, for example.

The user interface 200 shows data related to “workforce sustainability,” such as a first visualization 201 for “attrition by age group,” a second visualization for “attrition by job role,” and a third visualization for “attrition by department.” Here, the first visualization 201, the second visualization 202, and the third visualization 203 each open the same query for attrition data to the OLAP system to show the different aspects: the age group, job title, and department. These three different visualizations may require different states from the query and, accordingly, the same query may need to be loaded into memory three times, once for each visualizations.

Opening the same query multiple times may strain the network and computing resources of the server in addition to those of the client. Furthermore, loading data for numerous visualizations into the client's memory may cause performance regressions and memory shortages, even for more capable client computers such as desktop and laptop computers. And depending on the extent of memory required for the visualizations, less capable client computers such as tablets and smartphones may be not be capable of presenting all of the visualizations.

FIG. 3 shows a diagram 300 of a client 330 loading query data into memory 339 for each visualization based on a query of the OLAP system 350. The client 330 may be operated by a user 310. The client 330 may be configured similar to the client computer 110 of FIG. 1 described above. The OLAP system 350 may be considered similar to the OLAP system 150 of FIG. 1 described above. The client 330 of FIG. 3 may correspond to a client that has opened queries and generated the first visualization 201, the second visualization 202, and the third visualization 203 of FIG. 2 described above.

The client 330 includes memory 339. The memory 339 may include one or more primary memory devices coupled to one or more processors of the client. The one or more primary memory devices of the client 330 may comprise volatile memory, separate from non-volatile memory used for long-term storage. The one or more primary memory devices may include random access memory (RAM) or read only memory (ROM), for example.

A first query may be sent to the OLAP system 350, which obtains first query data 335 based on a query of a database. The first query data 335 may be provided to the client 330 (e.g., over a network). The first query data 335 received from the OLAP system 350 may be loaded onto the memory 339 for the first visualization 331. In this example, the second visualization 332 and the third visualization 333 rely on the same first query. The client 330 may query the OLAP system 350 again for both the second visualization 332 and the third visualization 333. The client 330 may duplicate the first query data 335 in the memory for the second visualization 332 and the third visualization 333. As such, the same first query data 335 may be stored in the memory 339 three separate times, once for a first visualization 331 (e.g., first visualization 20), once for a second visualization 332 (e.g., the second visualization 202), and once for a third visualization 333 (e.g., the third visualization 203). The client 330 may store separate instances of the same first query data 335 for each of the visualizations as each visualization may be modified during runtime and the corresponding query data may also be modified. Having separate query data for the different visualizations may allow for the visualizations to be modified in different ways.

As discussed above, loading numerous queries into memory can lead to performance regressions and memory shortage for capable clients such as desktop computer and laptop computers, and it may prevent less capable clients, such as tablets and smartphones, from displaying the visualizations and data. There is a need for improved memory management of query and visualization data at the client computer.

Techniques for improved memory management are described below. Memory consumption by the client computer may be reduced, and performance may be increased, by providing separate runtime data and metadata. The runtime data may be dynamic, changing as a result of a user (e.g., user 310) manipulating the visualizations, and as such, it may need to be distinct per visualization. The runtime data may include the set of dimensions used in the visualization, which text transformations are used, any sorting to be applied, conditional formatting requirements, and filter definitions, for example. While the runtime settings can be dynamically changed, the metadata may be defined by the query in the server, and as such, it may not be modified. The metadata may include the set of dimensions of an OLAP cube (e.g., a multidimensional database), for example. The embodiments described below separate the metadata and the runtime data such that memory consumption is reduced and the performance of generating visualizations is increased.

FIG. 4 shows a diagram 400 of a client loading a query into memory once and reused for each visualization based on the query, according to an embodiment. The client 430 may be configured similar to the client computer 110 of FIG. 1 described above. The OLAP system 450 may be considered similar to the OLAP system 150 of FIG. 1 described above.

The client 430 includes memory 439. The memory 439 may include one or more primary memory devices coupled to one or more processors of the client 430. The one or more primary memory devices of the client 430 may comprise volatile memory, separate from non-volatile memory used for long-term storage. The one or more primary memory devices may include random access memory (RAM) or read only memory (ROM), for example.

The client 430 of FIG. 3 may correspond to a client that has opened a query (e.g., requested query data from an OLAP system) and generated the first visualization 201, the second visualization 202, and the third visualization 203 of FIG. 2 described above. However, compared to the client 330 of FIG. 3, the client 430 of FIG. 4 is configured to separate runtime data and metadata in memory. For example, the client 430 can store the metadata for the first query data 435 separate from the runtime data for each visualization. In some embodiments, the metadata may be filled into a metadata store. Accordingly, once the first query data 435 is loaded into the memory 439 for the first time, if the user 410 opens another visualization for the same first query data 435, such as the second visualization 432 or the third visualization 433, the client computer 430 may not need to reload the same metadata for the first query data 435 into memory 439. Instead, new runtime settings for the visualizations may be instantiated and the visualization may be generated without opening another query.

Features and advantages of separate loading of runtime data and metadata into memory including improved memory management compared to other techniques that require the query to be loaded into memory multiple times (e.g., as described above with respect to FIG. 3). Separating runtime and metadata because reduces the amount of memory used for generating the same number of visualizations based on the same query. And since generating visualizations based on the same query may be common, processing and network performance of the client may be improved.

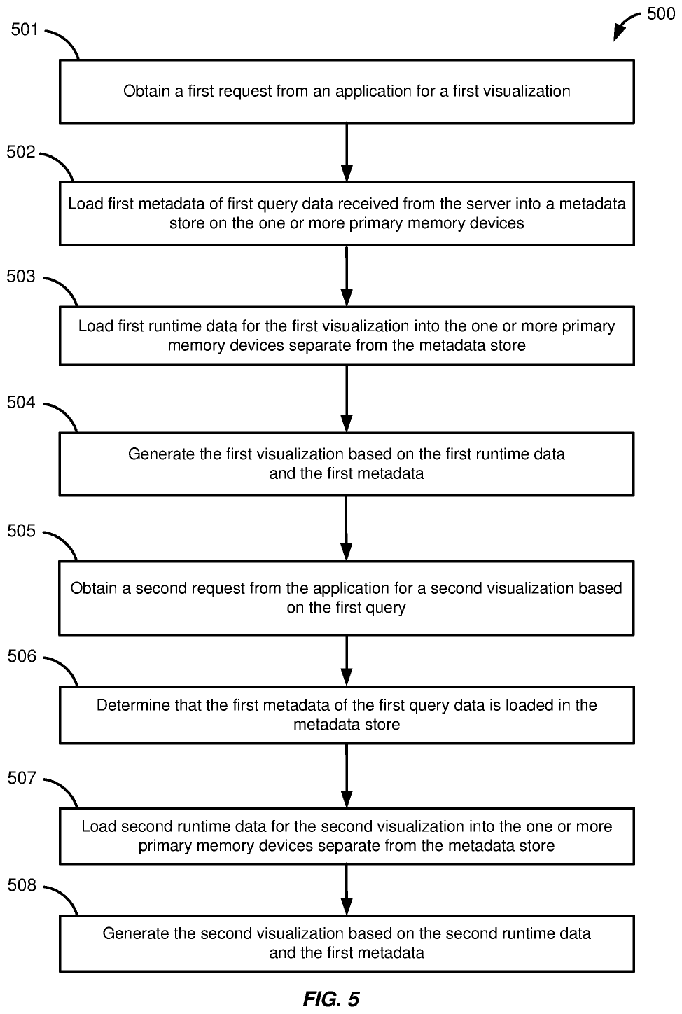

FIG. 5 shows a flowchart 500 of an exemplary method for loading query data into memory, according to an embodiment. The method may be implemented by a computer system in communication with a server, such as the client 430 in communication with the OLAP system 450 described above with respect to FIG. 4. In some embodiments, the computer system may be a mobile device and the server may an online analytics processing server. In some embodiments, the method includes the following actions.

At 501, the method includes obtaining a first request from an application for a first visualization based on a first query of a server. The first request from the application may be a result of the user opening a page including a visualization requiring data to be shown in the visualization.

At 502, the method includes loading first metadata of first query data received from the server into a metadata store on the one or more primary memory devices. The first query data may be received from an OLAP system in response to a query request made by the application.

At 503, the method includes loading first runtime data for the first visualization into the one or more primary memory devices separate from the metadata store. The first runtime data uses the first metadata of the metadata store without reloading the first metadata on the one or more primary memory devices.

At 504, the method includes generating the first visualization based on the first runtime data and the first metadata. The first visualization may be displayed to a user of the application and the runtime data may be changed as a result of the user manipulating the visualization (e.g., filtering the data or drilling down into hierarchical data).

At 505, the method includes obtaining a second request from the application for a second visualization based on the first query that the first visualization is based on.

At 506, in response to the second request at 505, the method includes determining that the first metadata of the first query data is loaded in the metadata store. The second request from the application may also be the result of the user opening the page, which also includes a second visualization.

At 507, in response to the determination that the first metadata of the first query data is loaded in the metadata store at 506, the method includes loading second runtime data for the second visualization into the one or more primary memory devices separate from the metadata store. The second runtime data uses the first metadata of the metadata store. The first metadata is not reloaded into the one or more primary memory devices in response to the second request.

At 508, the method includes generating the second visualization based on the second runtime data and the first metadata. The second visualization may be displayed to the user of the application and the second runtime data may be changed as a result of the user manipulating the second visualization (e.g., filtering the data or drilling down into hierarchical data). Thus, the application enables the user to manipulate both the first and second visualizations, thereby modifying the first and second runtime settings, while only requiring one instance of the metadata to be loaded into the memory of their client computer. That is, the first and second visualizations are generated using separate runtime data and the same metadata, thereby reducing memory consumption compared to techniques that load the query for each visualizations without separating runtime data and metadata.

In some embodiments, the method also includes modifying one or more of the first runtime data and the second runtime data in response to one or more user inputs made with respect to one or more of the first visualization and the second visualization without modifying the first metadata of the metadata store and without reloading the first metadata into the one or more primary memory devices.

In some embodiments, the method also includes loading second metadata of second query data received from the server into the metadata store on the one or more primary memory devices. In such embodiments, the method may also include loading third runtime data for a third visualization into the one or more primary memory devices separate from the metadata store. The third runtime data may use the second metadata of the metadata store without reloading the second metadata on the one or more primary memory devices.

In some embodiments, the method also includes querying the server for the first query data in response to the first request. In such embodiments, the method may also include receiving first query data from the server in response to the query, the first query data including the first metadata.

In some embodiments, the method also includes loading a filter definition into the one or more primary memory devices. In such embodiments, the generation of the first visualization and the generation of the second visualization may be based on the filter definition. The filter definition may be loaded into the one or more primary memory devices separate from the first runtime data and the second runtime data. In such embodiments, the filter definition may reference a unique key pointing to the first metadata.

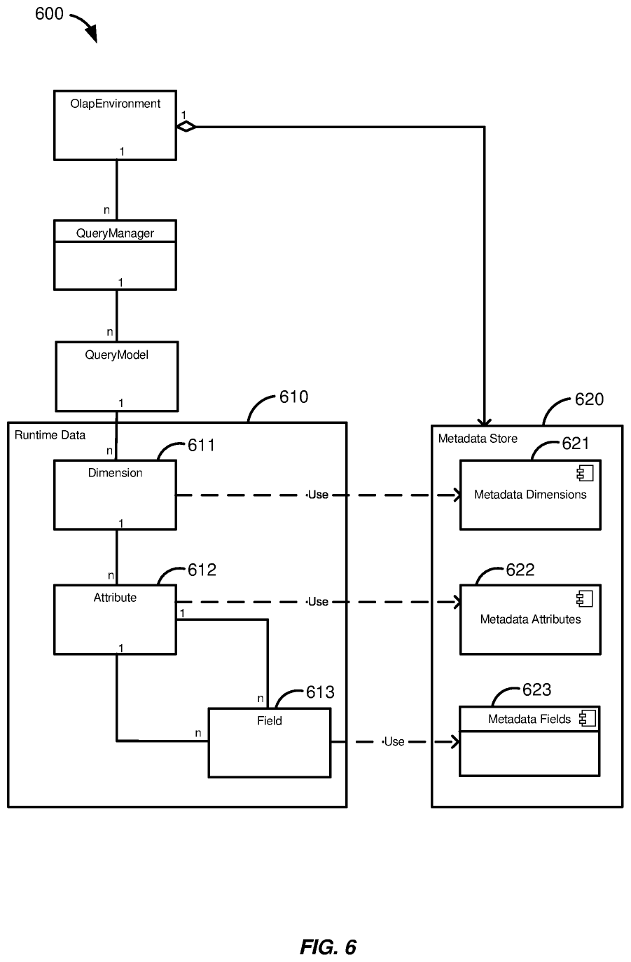

As described above, memory consumption may be reduced by using separate runtime data and metadata. FIG. 6 shows a simplified class diagram 600 showing separation of runtime data 610 and metadata, according to an embodiment. As shown in FIG. 6, metadata dimensions 621, metadata attributes 622, and metadata fields 623 may be loaded into a metadata store 620 that is separate from the runtime data 610. The runtime data 610 may be unique for each visualization based on a query while the metadata store may be accessible by visualizations using the same query.

As shown in FIG. 6, the dimension 611 of the runtime data 610 uses the metadata dimensions 621 of the metadata store 620, the attributes 612 of the runtime data 610 use the metadata attributes 622 of the metadata store 620, and the fields 613 of the runtime data 610 use the metadata fields 623 of the metadata store 620. As such, the metadata may not need to be duplicated in memory for each visualizations based on the same query, as described above.

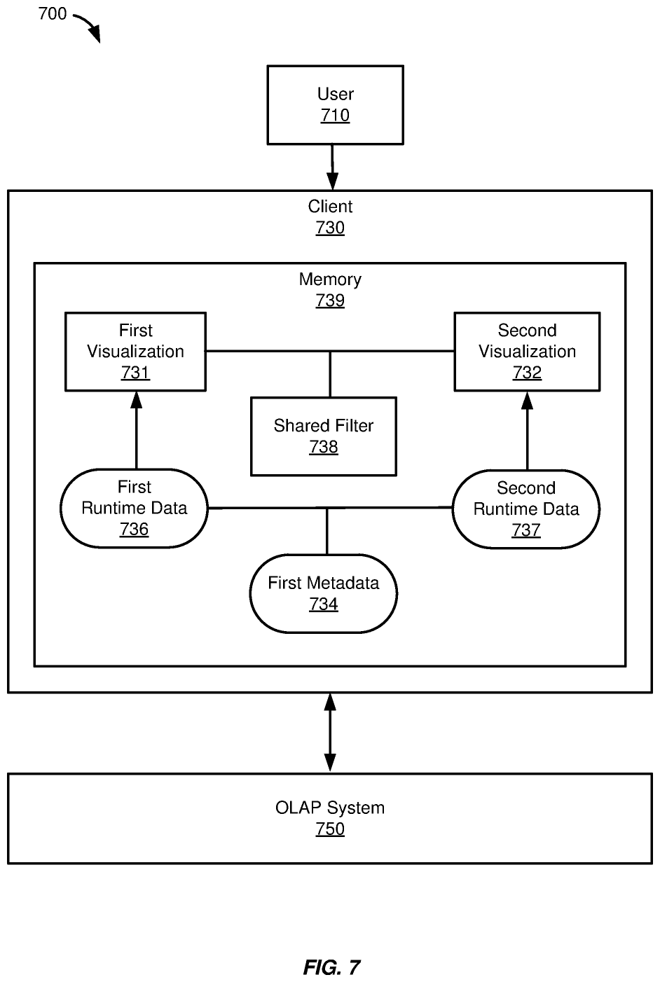

Another advantage of separating runtime settings from metadata is that other objects or entities used by the application become shareable as well, thereby further reducing memory consumption. For example, a single filter definition may be applied to multiple visualizations. FIG. 7 shows a diagram 700 of a client 730 sharing a filter definition 738 among visualizations, according to an embodiment. The client 730 may be configured similar to the client computer 110 of FIG. 1 described above. The OLAP system 750 may be considered similar to the OLAP system 150 of FIG. 1 described above. The user 710 is a user of the client 730.

The client 730 includes memory 739. The memory 739 may include one or more primary memory devices coupled to one or more processors of the client 730. The one or more primary memory devices of the client 730 may comprise volatile memory, separate from non-volatile memory used for long-term storage. The one or more primary memory devices may include random access memory (RAM) or read only memory (ROM), for example.

As shown in FIG. 7, first metadata 734 is loaded on the memory 739 and is being used by first runtime data 736 for a first visualization 731 and by second runtime data 737 for a second visualization 732. The first metadata 734 may have been obtained by querying the OLAP system 750. The first visualization 731 and the second visualization 732 may both share a shared filter definition 738. That is, the shared filter definition 738 may only be defined once and maybe used for multiple visualizations. A filter definition may include the name of the field being filter on, the dimension, whether there is a hierarchy on the dimension, a comparison operator (e.g., include or exclude), and values for which you want to filter, for example.

The filter definition 738 may not reference specific metadata of a query, but rather it may reference a unique key that points to the corresponding metadata. In some embodiments, the key to point to the corresponding metadata includes one or more of the following attributes: System, Query, Dimension, Field, Analytics Type, Metadata Hash. The System, Query, Dimension and Field may point to a unique instance for which the filter should be applied. However, there are embodiments where the same query may have different metadata, because of which other attributes Analytics Type and Metadata Hash may be needed. The Analytics Type may specify whether the query is used in an analytical way or for list reporting. The Metadata Hash may change if the query is changed on the server, such as via wrangling or other means.

With this approach, the filter definition 738 may be used for different queries, potentially on different OLAP systems, if the target of the key is part of that query. Thus, this technique further reduces the memory consumption, and because the filter definition is created and maintained only once the performance will further increase. In addition to filter definitions, conditional formatting definitions and sorting definitions may also be shared by multiple visualizations, for example.

Accordingly, features and advantages of the techniques for separate runtime data and metadata described herein includes reduced memory consumption and improved performance through sharing and non-duplication of data in memory.

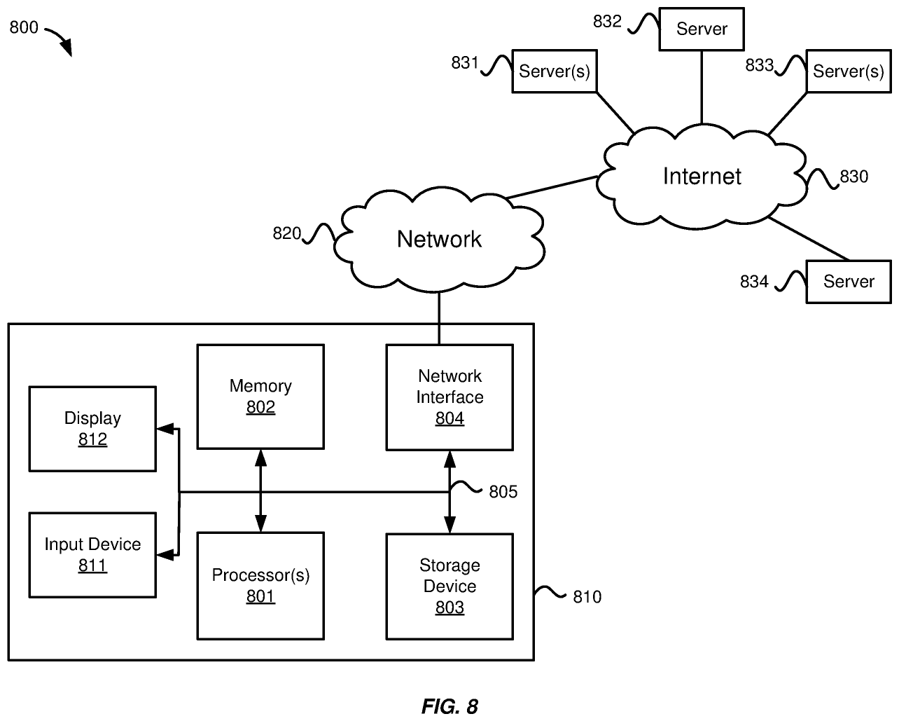

FIG. 8 shows a diagram of hardware of a special purpose computing machine for implementing separate runtime data from metadata. The hardware shown in FIG. 8 may be used to implement the client computer and OLAP system described herein. For example, the client computer described above may be implemented using the computer system 810 and the OLAP system may be implemented using one or more of the servers 831-834.

The computer system 810 includes a bus 805 or other communication mechanism for communicating information, and one or more processor(s) 801 coupled with bus 805 for processing information. The computer system 810 also includes a memory 802 coupled to bus 805 for storing information and instructions to be executed by processor 801, including information and instructions for performing some of the techniques described above, for example. This memory may also be used for storing programs executed by processor(s) 801. For example, the memory 802 may store programs executable by the processor(s) 801 to provide and use separate runtime data from metadata as described above. Possible implementations of this memory may be, but are not limited to, random access memory (RAM), read only memory (ROM), or both. A storage device 803 is also provided for storing information and instructions. Common forms of storage devices include, for example, a hard drive, a magnetic disk, an optical disk, a CD-ROM, a DVD, a flash or other non-volatile memory, a USB memory card, or any other medium from which a computer can read. Storage device 803 may include source code, binary code, or software files for performing the techniques above, for example. Storage device and memory are both examples of non-transitory computer readable storage mediums.

The computer system 810 may be coupled via bus 805 to a display 812 for displaying information to a computer user. An input device 811 such as a keyboard, touchscreen, and/or mouse is coupled to bus 805 for communicating information and command selections from the user to processor 801. The combination of these components allows the user to communicate with the system. In some systems, bus 805 represents multiple specialized buses, for example.

The computer system also includes a network interface 804 coupled with bus 805. The network interface 804 may provide two-way data communication between computer system 810 and a network 820. The network interface 804 may be a wireless or wired connection, for example. The computer system 810 can send and receive information through the network interface 804 across a local area network, an Intranet, a cellular network, or the Internet, for example. In the Internet example, a browser, for example, may access data and features on backend systems that may reside on multiple different hardware servers 831-834 across the network. The servers 831-834 may be part of a cloud computing environment, for example.

The above description illustrates various embodiments of the present disclosure along with examples of how aspects of the particular embodiments may be implemented. The above examples should not be deemed to be the only embodiments, and are presented to illustrate the flexibility and advantages of the particular embodiments as defined by the following claims. Based on the above disclosure and the following claims, other arrangements, embodiments, implementations, and equivalents may be employed without departing from the scope of the present disclosure as defined by the claims.

What is claimed is:

1. A computer system, comprising:
one or more processors;
one or more primary memory devices coupled to the one or more processors;
one or more machine-readable medium coupled to the one or more processors and storing computer program code comprising sets instructions executable by the one or more processors to:
obtain a first request from an application for a first visualization based on a first query of a server;
load first metadata of first query data received from the server into a metadata store on the one or more primary memory devices;
load first runtime data for the first visualization into the one or more primary memory devices separate from the metadata store, the first runtime data using the first metadata of the metadata store without reloading the first metadata on the one or more primary memory devices;
generate the first visualization based on the first runtime data and the first metadata;
obtain a second request from the application for a second visualization based on the first query that the first visualization is based on;
in response to the second request, determine that the first metadata of the first query data is loaded in the metadata store;
in response to the determination that the first metadata of the first query data is loaded in the metadata store, load second runtime data for the second visualization into the one or more primary memory devices separate from the metadata store, the second runtime data using the first metadata of the metadata store, the first metadata not being reloaded into the one or more primary memory devices in response to the second request; and
generate the second visualization based on the second runtime data and the first metadata.

2. The computer system of claim 1, wherein the computer program code further comprises sets instructions executable by the one or more processors to:
modify one or more of the first runtime data and the second runtime data in response to one or more user inputs made with respect to one or more of the first visualization and the second visualization without modifying the first metadata of the metadata store and without reloading the first metadata into the one or more primary memory devices.

3. The computer system of claim 1, wherein the computer program code further comprises sets instructions executable by the one or more processors to:
load second metadata of second query data received from the server into the metadata store on the one or more primary memory devices; and
load third runtime data for a third visualization into the one or more primary memory devices separate from the metadata store, the third runtime data using the second metadata of the metadata store without reloading the second metadata on the one or more primary memory devices.

4. The computer system of claim 1, wherein the computer program code further comprises sets instructions executable by the one or more processors to:
query the server for the first query data in response to the first request; and
receive the first query data from the server in response to the query, the first query data including the first metadata.

5. The computer system of claim 1, wherein the computer program code further comprises sets instructions executable by the one or more processors to:
load a filter definition into the one or more primary memory devices, the generation of the first visualization and the generation of the second visualization based on the filter definition, the filter definition being loaded separate from the first runtime data and the second runtime data.

6. The computer system of claim 5, wherein the filter definition references a unique key pointing to the first metadata.

7. The computer system of claim 1, wherein the computer system is a mobile device and wherein the server is an online analytics processing server.

8. One or more non-transitory computer-readable medium storing computer program code comprising sets of instructions to:
obtain a first request from an application for a first visualization based on a first query of a server;
load first metadata of first query data received from the server into a metadata store on one or more primary memory devices;
load first runtime data for the first visualization into the one or more primary memory devices separate from the metadata store, the first runtime data using the first metadata of the metadata store without reloading the first metadata on the one or more primary memory devices;
generate the first visualization based on the first runtime data and the first metadata;
obtain a second request from the application for a second visualization based on the first query that the first visualization is based on;
in response to the second request, determine that the first metadata of the first query data is loaded in the metadata store;
in response to the determination that the first metadata of the first query data is loaded in the metadata store, load second runtime data for the second visualization into the one or more primary memory devices separate from the metadata store, the second runtime data using the first metadata of the metadata store, the first metadata not being reloaded into the one or more primary memory devices in response to the second request; and
generate the second visualization based on the second runtime data and the first metadata.

9. The non-transitory computer-readable medium of claim 8, wherein the computer program code further comprises sets of instructions to:
modify one or more of the first runtime data and the second runtime data in response to one or more user inputs made with respect to one or more of the first visualization and the second visualization without modifying the first metadata of the metadata store and without reloading the first metadata into the one or more primary memory devices.

10. The non-transitory computer-readable medium of claim 8, wherein the computer program code further comprises sets of instructions to:
load second metadata of second query data received from the server into the metadata store on the one or more primary memory devices; and
load third runtime data for a third visualization into the one or more primary memory devices separate from the metadata store, the third runtime data using the second metadata of the metadata store without reloading the second metadata on the one or more primary memory devices.

11. The non-transitory computer-readable medium of claim 8, wherein the computer program code further comprises sets of instructions to:
query the server for the first query data in response to the first request; and
receive the first query data from the server in response to the query, the first query data including the first metadata.

12. The non-transitory computer-readable medium of claim 8, wherein the computer program code further comprises sets instructions executable by the one or more processors to:
load a filter definition into the one or more primary memory devices, the generation of the first visualization and the generation of the second visualization based on the filter definition, the filter definition being loaded separate from the first runtime data and the second runtime data.

13. The non-transitory computer-readable medium of claim 11, wherein the filter definition references a unique key pointing to the first metadata.

14. A computer-implemented method, comprising:
obtaining, by a computer system, a first request from an application for a first visualization based on a first query of a server;
loading, by the computer system, first metadata of first query data received from the server into a metadata store on one or more primary memory devices of the computer system;
loading, by the computer system, first runtime data for the first visualization into the one or more primary memory devices separate from the metadata store, the first runtime data using the first metadata of the metadata store without reloading the first metadata on the one or more primary memory devices;
generating, by the computer system, the first visualization based on the first runtime data and the first metadata;
obtaining, by the computer system, a second request from the application for a second visualization based on the first query that the first visualization is based on;
in response to the second request, determining by the computer system that the first metadata of the first query data is loaded in the metadata store;
in response to the determination that the first metadata of the first query is loaded in the metadata store, loading, by the computer system, second runtime data for the second visualization into the one or more primary memory devices separate from the metadata store, the second runtime data using the first metadata of the metadata store, the first metadata not being reloaded into the one or more primary memory devices in response to the second request; and
generating, by the computer system, the second visualization based on the second runtime data and the first metadata.

15. The computer-implemented method of claim 14, further comprising:
modifying, by the computer system, one or more of the first runtime data and the second runtime data in response to one or more user inputs made with respect to one or more of the first visualization and the second visualization without modifying the first metadata of the metadata store and without reloading the first metadata into the one or more primary memory devices

16. The computer-implemented method of claim 14, further comprising:
loading, by the computer system, second metadata of second query data received from the server into the metadata store on the one or more primary memory devices; and
loading, by the computer system, third runtime data for a third visualization into the one or more primary memory devices separate from the metadata store, the third runtime data using the second metadata of the metadata store without reloading the second metadata on the one or more primary memory devices.

17. The computer-implemented method of claim 14, further comprising:
querying the server for the first query data in response to the first request; and
receiving the first query data from the server in response to the query, the first query data including the first metadata.

18. The computer-implemented method of claim 14, further comprising:
loading a filter definition into the one or more primary memory devices, the generation of the first visualization and the generation of the second visualization based on the filter definition, the filter definition being loaded separate from the first runtime data and the second runtime data.

19. The computer-implemented method of claim 18, wherein the filter definition references a unique key pointing to the first metadata.

20. The computer-implemented method of claim 14, wherein the computer system is a mobile device and wherein the server is an online analytics processing server.
